(19) United States
(12) Patent Application Publication
(10) Pub. No.: US 2024/0158632 A1
(43) Pub. Date: May 16, 2024

(54) RESIN COMPOSITION

(71) Applicant: NAN YA PLASTICS CORPORATION, TAIPEI (TW)

(72) Inventors: Te-Chao Liao, TAIPEI (TW); Wei-Ru Huang, TAIPEI (TW); Hung-Yi Chang, TAIPEI (TW); Chia-Lin Liu, TAIPEI (TW)

(73) Assignee: NAN YA PLASTICS CORPORATION, TAIPEI (TW)

(21) Appl. No.: 18/074,526

(22) Filed: Dec. 5, 2022

(30) Foreign Application Priority Data
Oct. 27, 2022 (TW) 111140855

(51) Int. Cl. C08L 71/12

(52) U.S. Cl. CPC C08L 71/123; C08L 2205/03

(57) ABSTRACT

A resin composition is provided, which includes a novel low dielectric resin, a SBS resin, a cross-linking agent, a PPE resin, a halogen-free flame retardant, a spherical silica, and a siloxane coupling agent. The novel low dielectric resin is a maleimide resin. With the formula, the resin composition may improve resin fluidity and glass transition temperature (Tg) while maintaining low dielectric, thereby enhancing the overall processability.

### CROSS-REFERENCE TO RELATED APPLICATION

This application claims the priority benefit of Taiwan application serial no. 111140855, filed on Oct. 27, 2022. The entirety of the above-mentioned patent application is hereby incorporated by reference herein and made a part of this specification.

### BACKGROUND

### Technical Field

The disclosure relates to a resin composition, and particularly, to a low dielectric resin composition.

### Description of Related Art

In recent years, with the development of 5G communication, copper clad laminate materials have been developed towards the goal of lower dielectric properties. The current dielectric constant (Dk) of the substrate is about 3.2 to 5.0, which is not conducive to the application of high-frequency fast transmission in the future. In the current low dielectric formulas, a certain proportion of liquid rubber and polyphenylene ether (PPE) resin are added to reduce the electrical properties. However, when the proportion of liquid rubber and PPE resin is too high, resin fluidity is likely to decrease, resulting in an incomplete circuit filling and a defect in the substrate. In addition, the glass transition temperature (Tg) also decreases, so the poor heat resistance of the substrate affects the overall processability.

Therefore, a low dielectric resin composition has been developed, which has become an urgent objective for those skilled in the art to improve fluidity/fillability and Tg without affecting the electrical specification of low dielectric so as to enhance the overall processability.

### SUMMARY

The disclosure provides a resin composition which may improve resin fluidity and Tg while maintaining low dielectric at the same time, thereby enhancing the overall processability.

The resin composition of the disclosure includes a novel low dielectric resin, a SBS resin, a cross-linking agent, a PPE resin, a halogen-free flame retardant, a spherical silica, and a siloxane coupling agent. The novel low dielectric resin is maleimide resin.

In an embodiment of the disclosure, the above-mentioned maleimide resin has a number average molecular weight of 350 to 1000, and an equivalent weight of 550 g/equivalent.

In an embodiment of the disclosure, an addition amount of the novel low dielectric resin is 10 wt % to 30 wt %, an addition amount of the SBS resin is 10 wt % to 40 wt %, and an addition amount of the PPE resin is 40 wt % to 60 wt %, based on a total weight of the above-mentioned resin composition.

In an embodiment of the disclosure, an addition amount of the cross-linking agent is 5 wt % to 25 wt %, based on the total weight of the above-mentioned resin composition.

In an embodiment of the disclosure, an addition amount of the spherical silica is 20 wt % to 50 wt %, based on the total weight of the above-mentioned resin composition.

In an embodiment of the disclosure, an addition amount of the halogen-free flame retardant is 20 phr to 50 phr, based on the total weight of the above-mentioned resin composition.

In an embodiment of the disclosure, an addition amount of the siloxane coupling agent is 0.1 phr to 5 phr, based on the total weight of the above-mentioned resin composition.

In an embodiment of the disclosure, a dielectric constant of the above-mentioned resin composition is 3.0 to 3.2, and a dissipation factor is less than 0.0020.

In an embodiment of the disclosure, the resin fluidity of the above-mentioned resin composition is 38% to 43%.

In an embodiment of the disclosure, the Tg of the above-mentioned resin composition is greater than 220° C.

Based on the above, the disclosure reduces the proportion of other components (such as SBS resin, PPE resin, commercial rubber, etc.) in a formula by introducing the novel low dielectric resin into the resin formula, so as to effectively improve resin fluidity, fillability, and Tg while maintaining the electrical specification of low dielectric, thereby enhancing the overall processability.

### DESCRIPTION OF THE EMBODIMENTS

Hereinafter, embodiments of the disclosure are described in detail. However, these embodiments are exemplary, and the disclosure is not limited hereto.

As used herein, a range represented by “one numerical value to another numerical value” is a general representation which avoids listing all the numerical values in the range in the specification. Therefore, the recitation of a particular numerical range includes any numerical value within that numerical range as well as a smaller numerical range defined by any numerical value within that numerical range, as is the case with any numerical value and a smaller numerical range thereof in the specification.

A resin composition of the disclosure includes a novel low dielectric resin, a SBS resin, a cross-linking agent, a PPE resin, a halogen-free flame retardant, a spherical silica, and a siloxane coupling agent. Hereinafter, the above-mentioned various components are described in detail.

### Novel Low Dielectric Resin

In the embodiment, the novel low dielectric resin is, for example, a next-generation maleimide resin product MIR-5000 (purchased from Nippon Kayaku) with high heat resistance and low dielectric properties. A number average molecular weight is, for example, 350 to 1000, and an equivalent weight is, for example, 550 g/equivalent (g/eq.). In some embodiments, an addition amount of the novel low dielectric resin is, for example, 10 wt % to 30 wt %, based on a total weight of the resin composition. By introducing an appropriate amount of the novel low dielectric resin into a resin formula, the proportion of other components (such as SBS resin, PPE resin, commercial rubber, etc.) in the formula may be reduced, so as to effectively improve resin fluidity, fillability, and Tg while maintaining the electrical specification of low dielectric.

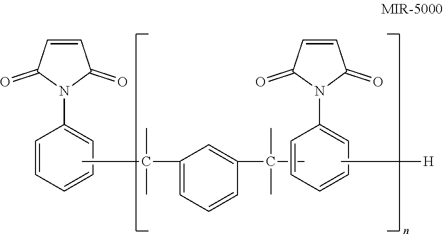

### SBS Resin

In the embodiment, the SBS resin has a styrene proportion of 10% to 40%, a 1,2 vinyl proportion of 60% to 90%, and a 1,4 vinyl proportion of 10% to 30%. A weight average molecular weight (MW) of the SBS resin is about 3500 to 5500. An addition amount of the SBS resin is, for example, 10 wt % to 40 wt %, based on the total weight of the resin composition. By replacing a liquid rubber with the SBS resin, phase separation between the resins is improved as well as fluidity and fillability, thereby enhancing the overall processability while maintaining low dielectric properties.

### Cross-Linking Agent

In the embodiment, the cross-linking agent is used to increase the degree of crosslinking of a thermosetting resin and adjust rigidity and toughness of a substrate and the processability. The type of use may be a triallyl cyanurate (TAC), a triallyl isocyanurate (TAIC), a trimethallyl isocyanurate (TMAIC), one or more combinations of a diallyl phthalate, a divinylbenzene, or a 1,2,4-Triallyl trimellitate. An addition amount of the cross-linking agent is, for example, 5 wt % to 25 wt %, based on the total weight of the resin composition.

### Polyphenylene Ether (PPE) Resin

In the embodiment, the PPE resin is a thermosetting PPE resin, and is a composition having styrene-type polyphenylene ether and acrylic-type polyphenylene ether at the end groups. An addition amount of the PPE resin is, for example, 40 wt % to 60 wt %, based on the total weight of the resin composition.

For example, the structure of the styrene-type polyphenylene ether is shown in Structural formula (A):

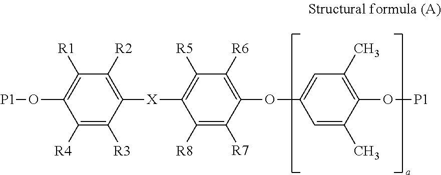

R1-R8 may be an allyl group, a hydrogen group, or a C1-C6 alkyl group, or one or more selected from the above-mentioned groups. X may be O (oxygen atom),

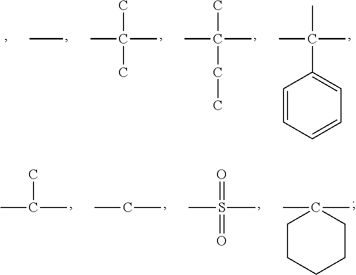

P1 is a styrene,

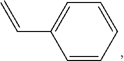

and a is an integer from 1 to 99.

The structure of the acrylic-type polyphenylene ether at the end is shown in Structural formula (B):

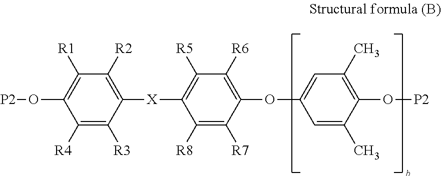

R1-R8 may be an allyl group, a hydrogen group, or a C1-C6 alkyl group, or one or more selected from the above-mentioned groups. X may be O (oxygen atom),

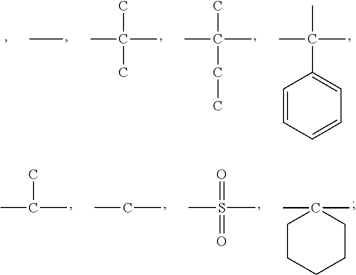

### P2 is

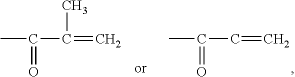

and b is an integer from 1 to 99.

Specific examples of the PPE resin include, but are not limited to, a bishydroxypolyphenylene ether resin (such as SA-90, available from Sabic Corporation), a vinyl benzyl polyphenylene ether resin (such as OPE-2st, available from Mitsubishi Gas Chemical Co.), a methacrylate polyphenylene ether resin (such as SA-9000, available from Sabic Corporation), a vinyl benzyl modified bisphenol A polyphenylene ether resin, or a vinyl extended chain saw phenylene ether resin. The aforementioned polyphenylene ether is preferably a vinyl polyphenylene ether.

### Halogen-Free Flame Retardant

In the embodiment, specific examples of the halogen-free flame retardant may be a phosphorus-based flame retardant which may be selected from phosphate esters, such as: a triphenyl phosphate (TPP), a resorcinol diphosphate (RDP), a bis Phenol A bis(diphenyl) phosphate (BPAPP), a bisphenol A bis(dimethyl) phosphate (BBC), a resorcinol diphosphate (CR-733S), or a resorcinol-bis(di-2,6-dimethylphenyl phosphate) (PX-200); may be selected from phosphazenes, such as: a polydi(phenoxy)phosphazene (SPB-100); an ammonium polyphosphate, a melamine phosphate (MPP, namely melamine polyphosphate), or a melamine cyanurate; may be selected from one or more combinations of flame retardants such as a DOPO-type, such as a DOPO (such as Structural formula (C)), a DOPO-HQ (such as Structural formula (D)), a double DOPO derived structure (such as Structural formula E), etc.; or an aluminum-containing hypophosphite lipid (such as Structural formula (F)). An addition amount of the halogen-free flame retardant is, for example, 20 phr to 50 phr.

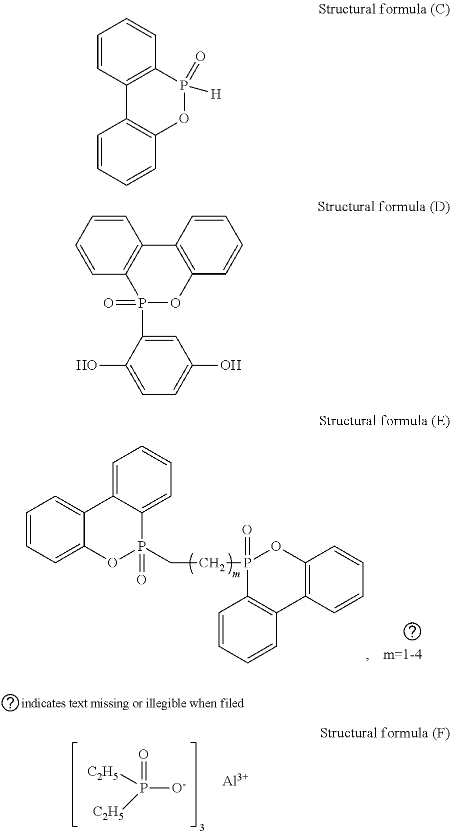

### Spherical Silica

In the embodiment, the spherical silica may preferably be prepared by a synthetic method, so as to reduce the electrical properties and maintain fluidity and fillablity. The spherical silica has surface modification of an acrylic or a vinyl, with a purity of about 99.0% or above, and an average particle size D50 of about 2.0 μm to 3.0 μm. An addition amount of the spherical silica is, for example, 20 wt % to 50 wt %, based on the total weight of the resin composition.

### Siloxane Coupling Agent

In the embodiment, the siloxane coupling agent may include, but is not limited to, a siloxane. In addition, according to the type of the functional group, it may be divided into an amino silane compound, an epoxide silane compound, a vinyl silane compound, an ester silane compound, a hydroxyl silane compound, an isocyanate silane compound, a methacryloxysilane compound, and an acryloxysilane compound. An addition amount of the siloxane coupling agent is, for example, 0.1 phr to 5 phr, which may enhance the compatibility and the cross-linking degree of a glass fiber cloth and a powder.

It should be noted that the resin composition of the disclosure may be processed into a prepreg and a copper foil substrate (CCL) according to actual design requirements. Therefore, the prepreg and the copper foil substrate produced by using the resin composition of the disclosure also has a better reliability (may maintain the required electrical properties). In more detail, the dielectric constant of the substrate produced by the resin composition is about 3.0 to 3.2, and the dissipation factor is less than about 0.0020.

Hereinafter, the above-mentioned resin composition of the disclosure is described in detail by means of experimental examples. However, the following experimental examples are not intended to limit the disclosure.

### Experimental Example

In order to prove that the novel low dielectric resin composition provided by the disclosure may effectively improve resin fluidity, fillability, and Tg, and maintain the low dielectric properties, the following is an experimental example.

### <Preparation of Resin Composition>

The resin composition shown in Table 1 (including: Comparative Example 1, Example 1, Example 2, Example 3, and Example 4) was mixed with toluene to form a varnish of a thermosetting resin composition, and the above-mentioned varnish was impregnated with a glass fiber cloth at room temperature (Nan Ya Plastic Co., Ltd., cloth type 1078LD), and then dried at 170° C. (an impregnation machine) for a few minutes to obtain a prepreg with a resin content of 79 wt %. Finally, 4 pieces of prepreg were stacked on top of each other between two copper foils with thicknesses of 35 μm, kept at a constant temperature for 20 minutes under the pressure of 25 kg/cm2 and the temperature of 85° C., heated to 210° C. again at a heating rate of 3° C./min, kept at the constant temperature again for 120 minutes, and then slowly cooled to 130° C. to obtain the copper foil substrate with a thickness of 0.59 mm, which was evaluated for various properties.

### <Evaluation Method>

The copper foil substrates produced in the respective examples and comparative examples were evaluated according to the following methods, and the results are shown in Table 1.
(1) Tg (° C.) was tested with a dynamic mechanical analyzer (DMA).
(2) Water absorption (%): After the sample was heated in a pressure cooker at 120° C. and 2 atm for 120 minutes, the weight change before and after heating was calculated.
(3) Solder heat resistance at 288° C. (seconds): The sample was heated in a pressure cooker at 120° C. and 2 atm for 120 minutes and then immersed in a solder furnace at 288° C., and the time required for the sample to explode and delaminate was recorded.
(4) Dielectric constant Dk: The dielectric constant Dk at a frequency of 10 GHz was tested with a dielectric analyzer HP Agilent E4991A.
(5) Dissipation factor Df: The dissipation factor Df at a frequency of 10 GHz was tested with a dielectric analyzer HP Agilent E4991A.
(6) Rate of resin fluidity: A press at 170° C. plus or minus 2.8° C. was used to depress with 200 PSI plus or minus 25 PSI for 10 minutes. After fusion and cooling, a disc was punched out, where the weight of the disc was precisely weighed, and the outflow of the resin was calculated.
(7) Resin phase separation (Slice analysis):
   Step 1: The copper foil substrate was cut into a size of 1 cm*lcm, and placed into a mold for resin grouting.
   Step 2: After the resin was completely dried and hardened, the sample was ground and polished.
   Step 3: A high-resolution microscope such as an OM/SEM was used to analyze the sample to confirm whether there was resin phase separation inside the sample.

### <Evaluation Result>

TABLE 1
Formula proportions and evaluation of properties of Comparative
Example 1 and Examples 1 to 4

| | | Comparative | | | | |
|---|---|---|---|---|---|---|
| | | Example 1 | Example 1 | Example 2 | Example 3 | Example 4 |
| Formula | PPE resin (%) | 50 | 50 | 50 | 40 | 30 |
| proportion | SBS resin (%) | 35 | 25 | 15 | 34 | 35 |
| | Novel low dielectric resin (%) | — | 10 | 20 | 10 | 20 |
| | Cross-linking agent (%) | 15 | 15 | 15 | 15 | 15 |
| | Halogen-free flame retardant (phr) | 30 | 30 | 30 | 30 | 30 |
| | Synthetic silica (%) | 40 | 40 | 40 | 40 | 40 |
| | Peroxide (phr) | 1 | 1 | 1 | 1 | 1 |
| | Siloxane coupling agent (phr) | 0.5 | 0.5 | 0.5 | 0.5 | 0.5 |

| | | | | | |
|---|---|---|---|---|---|
| B-stage curing temperature (° C.) | 130 | 130 | 130 | 130 | 130 |
| Glass transition temperature (° C.) | 205 | 238 | 255 | 226 | 248 |
| Water absorption (PCT ½ hour) (%) | 0.18 | 0.20 | 0.23 | 0.19 | 0.22 |
| Heat resistance (PCT ½ hour) | OK | OK | OK | OK | OK |
| Water absorption (PCT 2 hours) (%) | 0.24 | 0.25 | 0.29 | 0.24 | 0.27 |
| Heat resistance (PCT 2 hours) | OK | OK | OK | OK | OK |
| Dielectric constant Dk | 3.06 | 3.04 | 3.03 | 3.04 | 3.03 |
| (measured at a frequency of 10 GHz) | | | | | |
| Dissipation factor Df | 0.00180 | 0.00180 | 0.00185 | 0.00180 | 0.00180 |
| (measured at a frequency of 10 GHz) | | | | | |
| Rate of resin fluidity (%) | 36 | 38 | 41 | 39 | 43 |
| Resin phase separation (Slice analysis) | No phase | No phase | No phase | No phase | No phase |
| | separation | separation | separation | separation | separation |

Formula information in Table 1:
PPE resin: SA-9000 (purchased from Sabic Corporation)
SBS resin: SBS (purchased from Japan Caoda)
Novel low dielectric resin: MIR-5000 (purchased from Nippon Kayaku)
Cross-linking agent: triallyl isocyanuric acid
Halogen-free flame retardant: PQ-60 (purchased from Jinyi Chemical)
Synthetic silica: EQ2410-SMC (purchased from Sanshiji)
Peroxide: Luf
Siloxane coupling agent: siloxane compound

Please refer to Table 1. Compared with Comparative Example 1, Example 1 and Example 2 respectively added different addition amounts of the novel low dielectric resin to reduce (or replace) the addition amount of the SBS resin in the formula. Example 3 and Example 4 respectively added different addition amounts of the novel low dielectric resin to reduce (or replace) the addition amount of the PPE resin in the formula. The results show that the addition of an appropriate amount of the novel low dielectric resin (based on the total weight of the resin composition, the addition amount was 10 wt % to 30 wt %) is beneficial to improve Tg and resin fluidity of the copper foil substrates, such as Tg of Example 1, Example 2, Example 3, and Example 4 being all be greater than 220° C. (Tg of Comparative Example 1 without the novel low dielectric resin was 205° C.), and resin fluidity may be 38% to 43% (the resin fluidity of Comparative Example 1 without the novel low dielectric resin was 36%). In addition, Tg and resin fluidity may be improved with the addition of the novel low dielectric resin. Furthermore, compared with Comparative Example 1, with the addition of the novel low dielectric resin, Examples 1 to 4 may also maintain a favorable electrical specification of low dielectric (the dielectric constant was 3.0 to 3.2, and the dissipation factor was less than 0.0020).

To sum up, the disclosure may reduce the proportion of other components (such as SBS resin, PPE resin, commercial rubber, etc.) in a formula by introducing an appropriate amount of the novel low dielectric resin into the resin formula, so as to effectively improve resin fluidity, fillablity, and Tg while maintaining the electrical specification of low dielectric, thereby enhancing the overall processability.

Although the disclosure has been described with reference to the embodiments above, the embodiments are not intended to limit the disclosure. Any person skilled in the art may make some changes and modifications without departing from the spirit and scope of the disclosure. Therefore, the scope of the disclosure will be defined in the appended claims.

What is claimed is:

1. A resin composition, comprising:
a novel low dielectric resin, wherein the novel low dielectric resin is a maleimide resin;
a SBS resin;
a cross-linking agent;
a polyphenylene ether (PPE) resin;
a halogen-free flame retardant;
a spherical silica; and
a siloxane coupling agent.

2. The resin composition according to claim 1, wherein the maleimide resin has a number average molecular weight of 350 to 1000, and an equivalent weight of 550 g/equivalent.

3. The resin composition according to claim 1, wherein an addition amount of the novel low dielectric resin is 10 wt % to 30 wt %, an addition amount of the SBS resin is 10 wt % to 40 wt %, and an addition amount of the polyphenylene ether (PPE) resin is 40 wt % to 60 wt %, based on a total weight of the resin composition.

4. The resin composition according to claim 1, wherein an addition amount of the cross-linking agent is 5 wt % to 25 wt %, based on a total weight of the resin composition.

5. The resin composition according to claim 1, wherein an addition amount of the spherical silica is 20 wt % to 50 wt %, based on a total weight of the resin composition.

6. The resin composition according to claim 1, wherein an addition amount of the halogen-free flame retardant is 20 phr to 50 phr, based on a total weight of the resin composition.

7. The resin composition according to claim 1, wherein an addition amount of the siloxane coupling agent is 0.1 phr to 5 phr, based on a total weight of the resin composition.

8. The resin composition according to claim 1, wherein the resin composition has a dielectric constant of 3.0 to 3.2, and a dissipation factor of less than 0.0020.

9. The resin composition according to claim 1, wherein the resin composition has a resin fluidity of 38% to 43%.

10. The resin composition according to claim 1, wherein a glass transition temperature (Tg) of the resin composition is greater than 220° C.
